(19) United States
(12) Patent Application Publication
(10) Pub. No.: US 2020/0122870 A1
(43) Pub. Date: Apr. 23, 2020

(54) High speed case opener

(71) Applicant: Creative Packaging Solutions LLC, Lancaster, PA (US)

(72) Inventors: Thomas Wapinsky, New Providence, PA (US); John Mele, Forest City, PA (US); Paul Driscoll, Roaring Brook Township, PA (US)

(73) Assignee: Creative Packaging Solutions LLC, Lancaster, PA (US)

(21) Appl. No.: 16/657,582

(22) Filed: Oct. 18, 2019

Related U.S. Application Data
(60) Provisional application No. 62/747,996, filed on Oct. 19, 2018.

(51) Int. Cl. B65B 69/00; B65G 47/22

(52) U.S. Cl. CPC B65B 69/0033; B65G 47/22

(57) ABSTRACT

A high speed case opener is comprised of an ingress section, and transition section, and an egress section. Boxes entering the high speed case opener on a conveyor are cut by a pair of rotating blades mounted on either side of the conveyor. Movement of the box is paused after it is cut and the trajectory of the box is redirected 90° by operation of a redirection means located within the transition section. After being so redirected, the box enters the egress section where a pair of rotating blades cut the box on the two previously uncut sides, forming a lid which can be readily removed to access the contents of the box. The rotating blades are each enclosed within a deflection segment and are only exposed when a box presses against a pair of deflection segments.

### FIELD OF THE INVENTION

The subject matter of this application relates to cutting devices. More particularly, the subject matter of this application pertains to devices for cutting boxes made of cardboard or similar materials. Even more particularly this application pertains to high throughput devices for opening cardboard boxes.

### BACKGROUND

Often, manufacturers will package their products in single-species boxes and a co-packer will create boxes containing multiple product species. For example a potato chip manufacturer may fill boxes of either ripple-cut, BBQ, plain, or sour cream and onion chips. A co-packer may take those boxes, open them, remove the contents and repackage the potato chips in boxes containing some combination of chips which are targeted towards different stores or markets as needed. A co-packing company may also mix different types of items in a single box as needed by the purchaser, as may be the case when a store needs a few of several product types, but doesn't have the need or storage space for full cases of each item.

One way of opening such boxes is to simply give a worker a hand-held box cutter which is little more than a razor blade with a handle, and point them to a stack of boxes. Although this works, it is inefficient and includes an element of danger since a person is swinging a handled razor blade as fast as they can to keep the line moving.

One unfamiliar with such a packing line might assume boxes are opened as they are probably opened at home, with one cutting the packaging tape and opening the flaps of a box. However, this creates more efficiency problems than simply cutting entirely around the box and lifting off the resulting lid.

Some manufacturers have automated the box opening process using machines that mimic the action of a person and moves a knife around the box. Some of these machines are designed to only open a specific size of box such as boxes of cigarette cartons, while others have active sensing means which first measure the box and then move the knife accordingly.

In such uses, sealed boxes are loaded onto a “line” or “conveyor” where they move toward the opening machine, are opened, and then continue down the conveyor for further processing.

These existing solutions are fine for small throughput lines or those with a lot of cheap labor available (a person with a box cutter), high throughput lines that only open one size of box (the fixed size machines) or low-mid-throughput lines where several different sizes of boxes are on a line at any given time (the active sensing machine).

Commonly though, a co-packing line may need to open several boxes of one type and then several of another type so a fixed size opener is of limited use and an active sensing opener is inefficient because it takes time to measure each box even if the previous hundred boxes were all the same size and shape.

### SUMMARY

The primary objective of the subject matter of this application is to provide a device for opening boxes. A further objective of the subject matter of this application is to provide a device for opening boxes which cuts the top of a sealed box so the resulting lid can be easily removed. Yet a further objective is to provide a cutting means which utilizes a rotating blade which can cut a box when rotating, but which can be handled safely when not rotating. A further objective of the subject matter of this application is to provide a device to open boxes on a high throughput conveyor line which can be adjusted to work with nearly any size box routinely encountered on such a line.

The subject matter of this application satisfies these objectives.

Disclosed herein is a box opening device in which a box is cut on two sides as the box is entering the device along a path and the box is cut on the two sides not previously cut as it exits the device.

The position and cutting depth of the blades are adjustable, as is the speed of the boxes moving though the device. Further, the blades are round and spin along an axis when in use. This allows the blades to effectively cut without needing to have a razor-like edge, which lessens the risk of injury and increases the number of boxes which can be opened before the blade needs to be replaced or sharpened.

The result of a box moving through the device is a box in which the top section has been cut so that the newly formed lid can be easily removed.

### BRIEF DESCRIPTION OF THE DRAWINGS

FIG. 1 is a perspective view of the high speed case opener.

FIG. 2 is another perspective view of the high speed case opener.

FIG. 3 is a simplified top plan view of the high speed case opener.

FIG. 4 is an elevation of the entrance of the ingress section.

FIG. 5 is an elevation of the exit of the egress section.

FIG. 6 depicts a portion of high speed case opener highlighting an exemplary cutting means and a movement means.

FIG. 7 is view of an isolated cutting means.

FIG. 8 is a mid-section view of an isolated cutting means.

FIG. 9 is a perspective view of a box.

FIG. 10 is an illustration of a box moving into the high speed box opener, passing the paired cutting means of the ingress section and being cut by rotating cutting blades.

FIG. 11 is an illustration of a box moving out of the high speed box opener, passing the paired cutting means of the ingress section and being cut by rotating cutting blades.

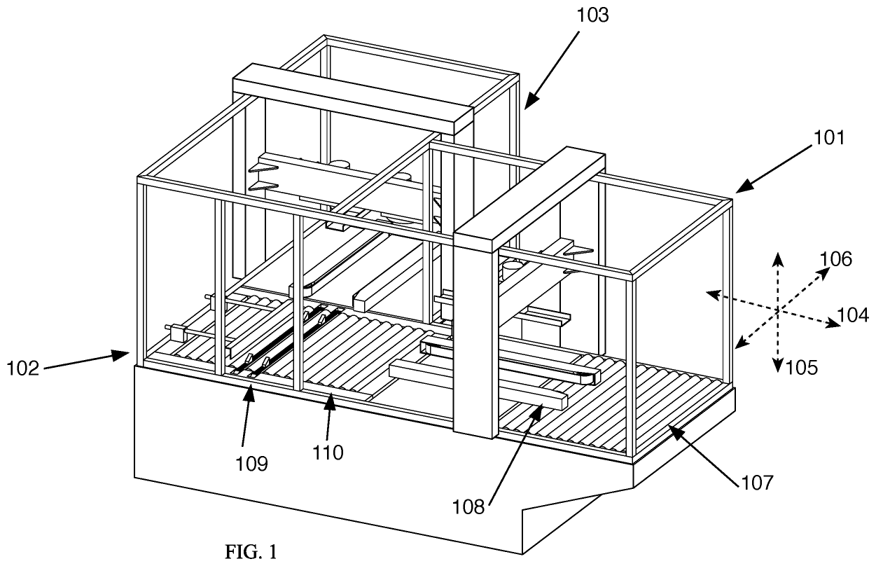

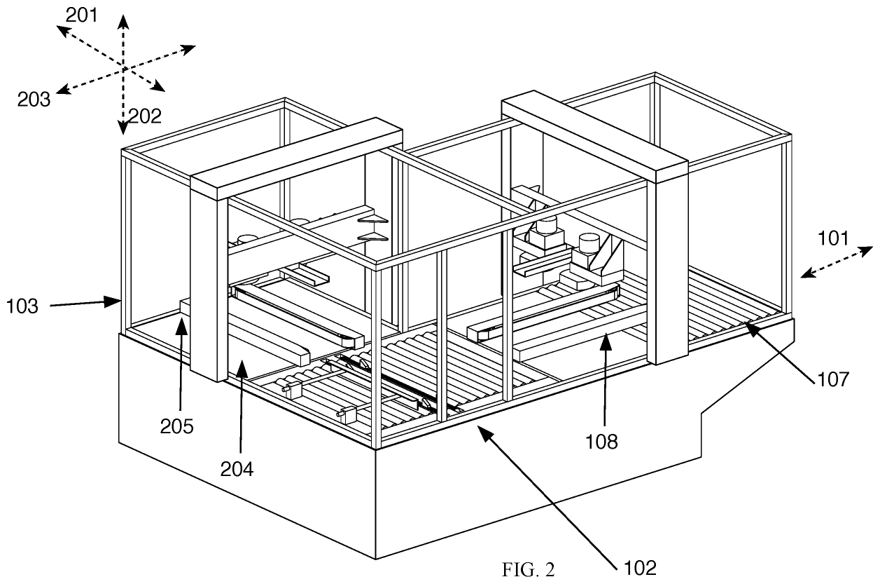

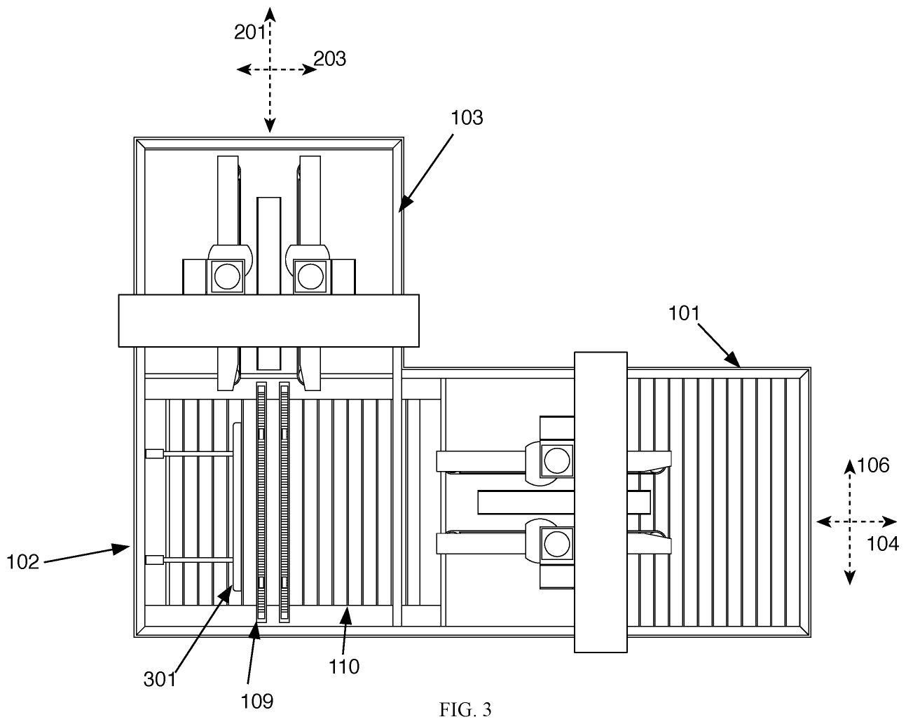

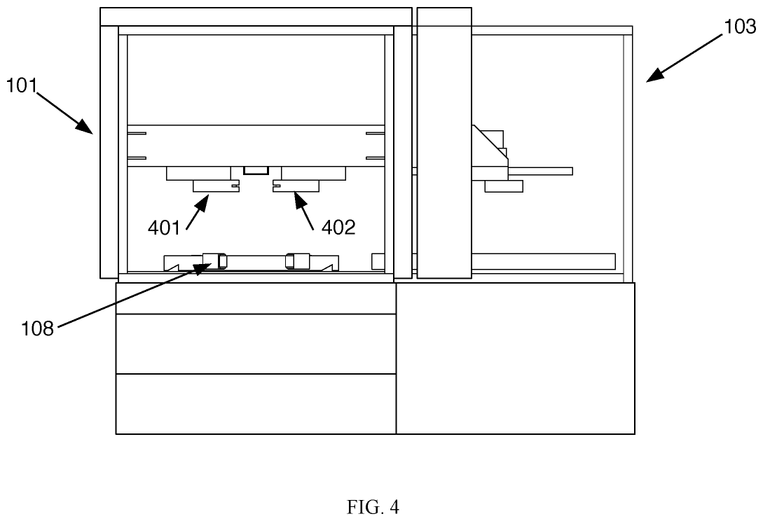

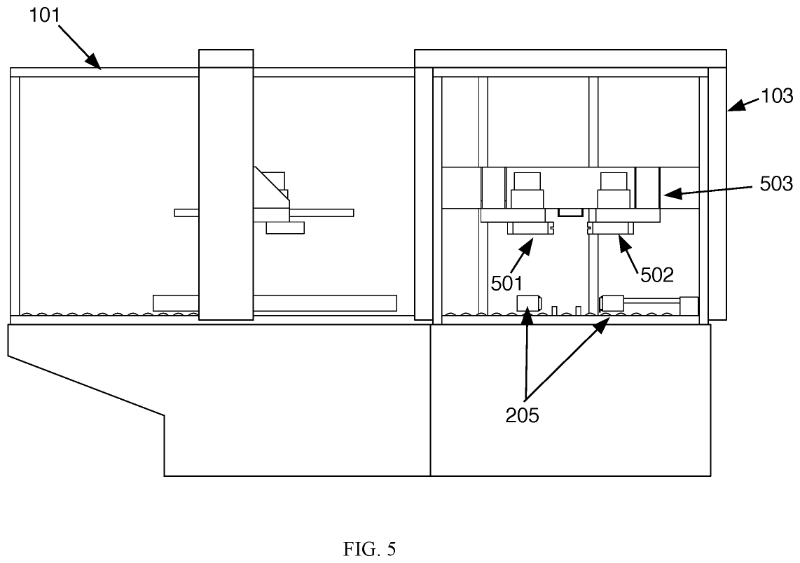

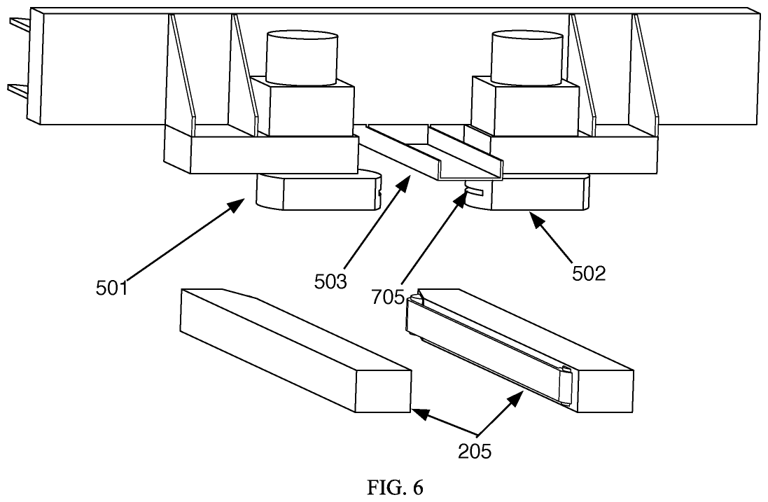

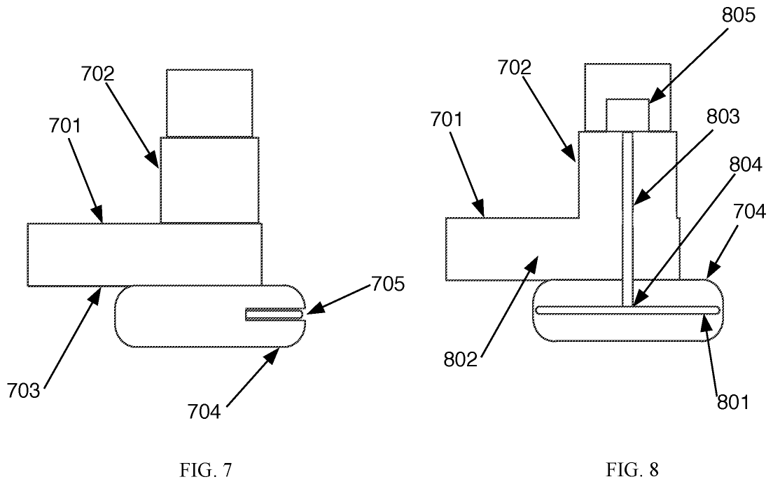

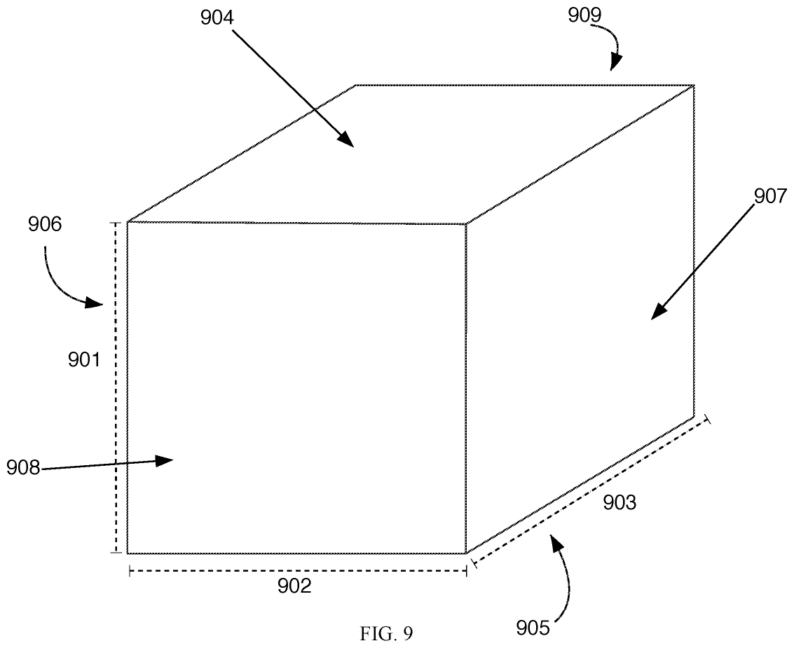

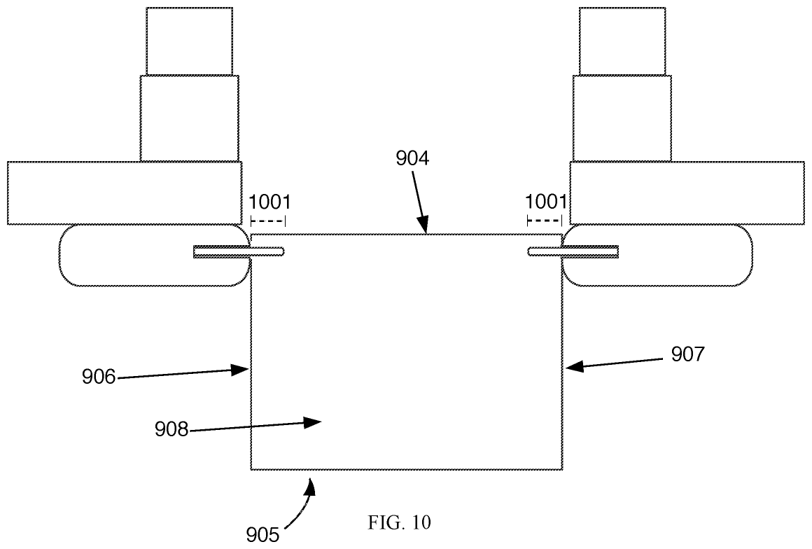

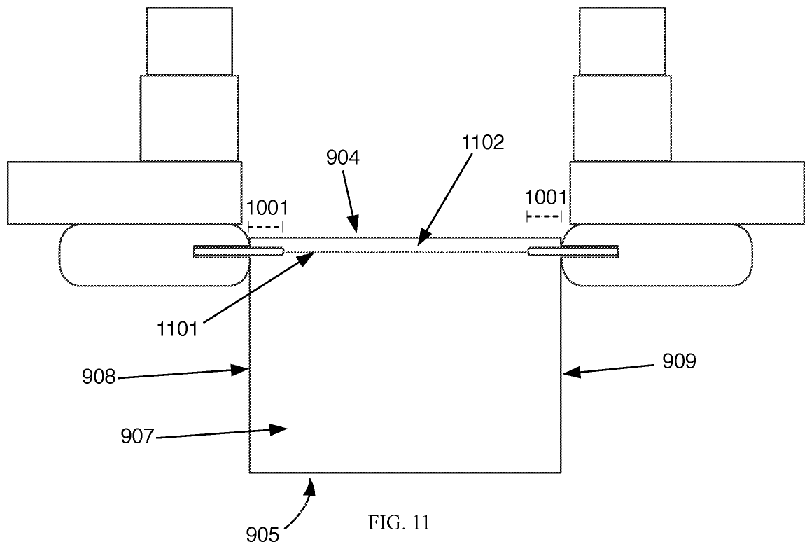

### DETAILED DESCRIPTION OF THE DRAWINGS

The following description and drawings referenced therein illustrate embodiments of the application's subject matter. They are not intended to limit the scope. Those familiar with the art will recognize that other embodiments of the disclosed method are possible. All such alternative embodiments should be considered within the scope of the application's claims.

The first digit of each reference number indicates the drawing where the referenced feature either is first called out or where it is best shown. Reference numbers are not necessarily discussed in the order of their appearance in the figures.

As used herein, a “box” refers to a cubic structure having an inner compartment. For convenience in drafting and reading, a box is presumed to be constructed primarily of cardboard although a box could be constructed of another material. Similarly, references made herein to a rotary cutting blade are not limited to those rotary cutting blades made of metal, but includes all materials suitable for carrying out the function of said blades e.g. ceramic blade. Drawings are not necessarily to scale. Often the subject matter of this application may be surrounded by a cage or other such structure to comply with standard safety practices meant to prevent one from accidentally encountering a pinch point or edge. Such a cage or other structure is not shown in the drawings so the subject matter of this application is not obscured.

The application discloses a high speed case opener comprising multiple cutting blades and a mechanism for changing the vector of a box moving through the high speed case opener. An advantage of this design is that the case opener can be adjusted to accommodate a range of box sizes and cardboard thicknesses and easily adjusted to new dimensions when a change is needed to accommodate differently sized boxes. The disclosed high speed case opener comprises a cutting means which adjusts in reaction to encountering the box so that the cutting means rides against the box. A blade is exposed from the cutting means to cut into the box. Ideally, when not in use the blade is hidden from sight and entirely contained within the cutting means so the possibility of injury due to the blade is largely eliminated.

A high speed case opener comprises an ingress section (101), a transition section (102), and an egress section (103).

The ingress section is comprised of a first axis (104), a second axis (105) and a third axis (106). The ingress section further comprises a conveyor (107), a movement means (108), a first cutting means (401), and a second cutting means (402).

The transition section comprises a redirection means (109) and a conveyor (110).

The egress section is comprised of a first axis (201), a second axis (202) and a third axis (203). The egress section further comprises a conveyor (204), a movement means (205), a first cutting means (501), and a second cutting means (502).

Each said conveyor may be comprised of rollers, belts, or other suitable components.

A box comprises a height (901) parallel to the second axis of the ingress section (105) and also parallel to the second axis of the egress section (202), a width (902) parallel to the third axis of the ingress section (106), and a depth (903) parallel to the third axis of the egress section (203). A box further comprises a top surface (904), a bottom surface (905), a first side (906), a second side (907), a third side (908), and a fourth side (909).

When a box is placed onto the conveyor of the ingress section (101) the box is acted up by a movement means (108) and moved past the first cutting means (401) and the second cutting means (402) of the ingress section and into the transition section (102). In a most highly preferred embodiment the movement means is a powered paired belt system which grips the the first side and second side of the box and forces the box to move toward the transition section.

The position of the first cutting means and the second cutting means of the ingress section are user adjustable along the second and third axis of the ingress section to accommodate the height and width of the boxes, respectively.

A box enters the transition section moving parallel the the first axis of the ingress section until it reaches a blockage (301) and the redirection means of the transition section (109) moves the transverse to the first axis of the ingress section such that the box is moving parallel to the first axis of the egress section. The box is acted up by the movement means (205) of the egress section, moved past the first cutting means and the second cutting means of the egress section at which point the box is ejected from the high speed case opener. In a most highly preferred embodiment the movement means is a powered paired belt system which grips the the third side and fourth side of the box and forces the box to move out from the high speed case opener.

In most preferred embodiments, the movement means of the ingress section and the movement means of the egress section are comprised of paired belt drives located beneath the respective cutting means and adjustable so that the paired belts grip the box and feed the box past the respective cutting means.

The position of the first cutting means and the second cutting means of the egress section are user adjustable along the second and third axis of the egress section to accommodate the height and depth of the boxes, respectively.

Each said cutting means is held by an adjustable arm (e.g. 503). Said adjustable arm being capable of deflecting laterally when a box passes against the cutting means. In this way said cutting means could be set slightly smaller than the width or depth of a box and be pushed aside by the box so that the cutting means is in contact with, or nearly within contact with a side of a box when the box is being moved past the cutting means. In a preferred embodiment the cutting means is connected directly, or via said adjustable arm, to a compressible structure such as a spring or piston such that any lateral motion caused by a box pressing against the cutting means is against pressure, ensuring the cutting means deflects no more than necessary to allow the box to pass between paired cutting means. In a preferred embodiment the position of the first and second cutting means is accomplished by adjusting the adjustable arm, which comprises user adjustable means to change the position of the adjustable arm, and thereby the associated cutting means. In a most highly preferred embodiment the user adjustable means are comprised of male and female threaded adjusting components.

There are four cutting means disclosed. For brevity and clarity, a single cutting means will be illustrated and described in detail. This description applies to each of the four cutting means with the caveat that each pair of cutting means is comprised of a right handed unit and a left handed unit.

The cutting means comprises a mount (701) connected to a said adjustable arm (503), a housing (702) and a rotary cutting blade (801). Said housing is comprised of an inside compartment (802), an outer surface (703), and a deflection segment (704) comprising a gap (705). In a most preferred embodiment, said mount comprises a powered spindle (803) having a terminus (804) located within the inside compartment of the cutting means. Said terminus of the spindle is attached to the rotary cutting blade. In this way the rotary cutting blade is fixed in position in relation to said mount.

When not in use, the rotary cutting blade is completely within the deflection segment of the cutting means. When in use, the powered spindle is acted up by a motor (805) causing it, and thereby they rotating blade, to spin. When pressure is exerted against the deflection segment of the housing by a box, the deflection segment deflects an amount (e.g. 1001) to expose the rotating cutting blade which cuts into the box. The pressure needed to cause the deflection segment of the housing to deflect, as well as the amount the defecting face will deflect is adjustable so that the blade can be set to cut no more than necessary without the box being crushed against the deflection segment of the housing. In this manner, the blade is hidden when not in use, and when in use, is exposed just enough to cut the box. This reduces the risk of injury to both a person and to the contents of the box. In most preferred embodiments, movement of the housing due to the pressure against the face of the housing is restrained by a compressible means such as a spring or piston.

In a most preferred embodiment, the pressure needed to move the deflection segment of the housing and the pressure needed to move the housing of the cutting means when each encounters a load are separately adjustable.

In a most preferred embodiment this motor is integrated into the mount, although such a motor could be distal to the rotating cutting blade and connected to the rotating cutting blade using methods well known in the mechanical arts. In testing, we have found a rotating blade has several advantages over something like a static razor blade. A rotating blade used in this manner can be relatively blunted compared to a razor blade without affecting cutting ability. Unlike a stationary blade in which only a portion of the blade is ever used to cut, the rotation of the blade ensures even wear of the blade. Since a razor edge isn't needed, a comparatively blunt rotating blade can be used which does not need to be removed and replaced as often as a blade that requires a fine cutting edge, saving the time and expense of changing blades, and the associated risk involved with handling a sharp blade. Testing has shown a circular blade having a dual edge 5° bevel with a length of 20/1000th of an inch is sufficiently sharp to cut most boxes yet sufficiently blunt that the blade can be lightly pinched by a user along the cutting edge without breaking skin. Additionally, the rotating cutting blade resists the accumulation of glue residue from the cardboard, further extending the usable life of the blade.

In a most highly preferred embodiment the ingress section and the egress section each comprise a top stabilizer (601) which can press down on a box to hold such box in place in case the box begins to tilt when the cutting means are contacted.

In its most anticipated use, the high speed case opener is a bend or elbow in a larger conveyor belt system. A representative box is measured and these measurements are used to adjust the position of the said cutting means (401, 402, 501, 502) so the box can pass between each pair of cutting means and so that each said gap (e.g. 705) is below the top surface of the box (904). The amount (e.g. 1001) of the rotating cutting blade that will be exposed when a box moves between each pair of cutting means is adjusted so the box is cut sufficiently deep to breach the box, but not cut so deeply as to damage the contexts of the box. Once these initial adjustments are made a number of boxes are run thought the high speed box opener to confirm the adjusted settings. To run a box though the high speed box opener it is placed on a section of preceding conveyor which moves boxes toward the high speed box opener. At a point, the box is gripped by the movement means of the ingress section such as a paired belt system (108) and fed under a top stabilizer (601), and past the paired cutting means (401 and 402) toward the transition section (102). As the box moves past the paired cutting means, the deflection segments (e.g. 704) are pushed away by the box exposing the rotating cutting blades (e.g. 801) which cuts the box along the first (906) and second (907) sides of the box (the cut of the second side of the box is illustrated in 1101). The path of the box is blocked by the blockage (301) and the redirection means (109) moves the box in a direction 90° from the path of the box though the ingress section. The box then passes through the egress section, similarly encountering the cutting means of the egress section, however as the box has been redirected in the transition section, the rotating cutting blades of the cutting means of the egress section cut the third (908) and fourth (909) sides of the box. In this manner, sides 1, 2, 3 and 4 of the box are cut at the same position relative to the top (904) creating a lid (1102) to the box which can be easily removed and the contents of the box accessed.

We claim:

1. A high speed case opener comprising of an ingress section, a transition section, and an egress section;
a. said ingress section comprising a first axis, a second axis, a third axis, a conveyor, a movement means, a first cutting means, and a second cutting means;
i. said first cutting means of the ingress section is separated from the second cutting means of the ingress section by a width;
ii. said ingress section capable of accepting a load entering said ingress section and moving said load on the conveyor of the ingress section into the transition section
b. said transition section comprising a redirection means and a conveyor;
c. said egress section comprising a first axis, a second axis, a third axis, a conveyor, a movement means, a first cutting means, and a second cutting means;
i. said first cutting means of the egress section is separated from the second cutting means of the egress section by a width; and
ii. said egress section capable of accepting a load entering said egress section from the transition section and moving said load on the conveyor of the egress section to outside the high speed case opener.

2. The high speed case opener of claim 1 in which the movement means of said ingress section is adapted to move a load along the axis of the ingress section from the outside of the high speed case opener to the transition section.

3. The high speed case opener of claim 1 in which the redirection means of said transition section is adapted to move a load along the axis of the egress section from the transition section to the egress section.

4. The high speed case opener of claim 1 in which the movement means of said egress section is adapted to move a load along the first axis of the egress section to outside of the high speed case opener.

5. The high speed case opener of claim 1 in which the first cutting means and the second cutting means of the ingress section are each comprised of a housing, an adjustable arm, and a rotary cutting blade;
a. each said housing further comprising a deflection segment comprising a gap; and
b. each said adjustable arm comprising user adjustable means to change the distance between the first cutting means and the second cutting means, and to change the distance between a cutting means and the conveyor of the ingress section.

6. The high speed case opener of claim 1 in which the first cutting means and the second cutting means of the ingress section are each comprised of a housing, an adjustable arm, and a rotary cutting blade;
a. each said housing further comprising a deflection segment and an opening;
b. said face of the housing of the first cutting means and said deflection segment of the housing of the second cutting means are separated by a space slightly less than approximately equal to the size of a load moving through the ingress section.

7. The high speed case opener of claim 1 in which the first cutting means and the second cutting means of the egress section are each comprised of a housing, an adjustable arm, and a rotary cutting blade;
a. each said housing further comprising a deflection segment comprising a gap; and
b. each said adjustable arm comprising user adjustable means to change the distance between the first cutting means and the second cutting means, and to change the distance between a cutting means and the conveyor of the egress section.

8. The high speed case opener of claim 1 in which the first cutting means and the second cutting means of the egress section are each comprised of a housing, an adjustable arm, and a rotary cutting blade;
a. each said housing further comprising a deflection segment and an opening;
b. said face of the housing of the first cutting means and said deflection segment of the housing of the second cutting means are separated by a space slightly less than approximately equal to the size of a load moving through the egress section.

9. The high speed case opener of claim 1 in which the first axis of the ingress section and the first axis of the egress section form a right angle with a vertex in the transition section

10. The high speed case opener of claim 1 in which each said cutting means comprises a housing and a rotary cutting blade;
a. said housing comprising an inside compartment and a deflection segment;
i. said inside compartment being sufficiently large to contain said rotary cutting blade;
ii. said deflection segment comprising an outer surface and a gap though which said rotary cutting blade can extend;
b. Said rotary cutting blade being annular in shape and comprising an edge, a vertical axis, and a horizontal axis;
i. said edge of the rotary cutting blade being parallel to the horizontal axis of the rotary cutting blade and capable of spinning along the vertical axis of said rotary cutting blade;
c. said deflection segment of the housing being adapted to retract laterally in response to a load pressing against the face of the housing,
d. such movement of the deflection segment of the housing being sufficient to expose the rotary cutting blade through the gap of the face by a user-defined amount and
e. said deflection segment of said housing being adapted to contain the rotary cutting blade fully when no load is in contact with the face of the housing.
